(19) United States
(12) Patent Application Publication
(10) Pub. No.: US 2015/0001859 A1
(43) Pub. Date: Jan. 1, 2015

(54) Latch Assembly for Cargo Door

(71) Applicant: KenCon Hardware Corporation, Bristol, IN (US)

(72) Inventors: Clyde Ricky Minix, Edwardsburg, MI (US); Thomas L. Del Vecchio, Middlebury, IN (US)

(21) Appl. No.: 13/931,760

(22) Filed: Jun. 28, 2013

(51) Int. Cl. E05B 5/00; E05B 15/00; E05B 9/02

(52) U.S. Cl. CPC E05B 5/006; E05B 9/02; E05B 15/00
USPC 292/66

(57) ABSTRACT

A latch assembly for a cargo door assembly that accommodates for dimensional and structure variations is cargo door assemblies to ensure a secure latching mechanism. The latch assembly uses a two piece design that includes a handle unit and a separate plunger unit to enable its use with cargo doors of varying thickness. The latch assembly also uses spacers to selectively position a plunger carriage within a plunger housing to selectively adjust the position of an extensible plunger supported by the carriage relative to the door frame, which ensures that the plunger properly engages the door frame and securely holds the cargo door closed.

This invention relates to a latch assembly and in particular a latch assembly for vehicle cargo doors and the like.

### BACKGROUND AND SUMMARY OF THE INVENTION

Exterior storage compartments are common features on recreational vehicles, trailers and the like. Storage compartments are typically enclosed by hinged cargo doors with latch assembles that hold the doors closed against an external door frame set within an opening in the vehicle or trailer sidewall. Conventional cargo door latch assemblies include a handle that is operatively connected to a plunger that extends to engage the door frame thereby holding the door closed. A common problem found with conventional cargo door and latch assemblies is that dimensional and structural variations in door frames, doors and door seals can prevent the effective operation of the latch assembly thereby compromising not only the seal but the security of the storage compartment.

The present invention provides a latch assembly that accommodates for dimensional and structure variations in cargo door assemblies to ensure a secure latching mechanism. In the exemplary embodiment, the latch assembly allows for selective adjustment of the position of the plunger relative within the assembly itself to ensure that the plunger properly engages the strike plate on the door frame when extended. The latch assembly uses a two piece design that includes a handle unit and a separate plunger unit. The plunger unit includes a plunger carriage, which carries the extensible plunger. The plunger carriage is mounted within a housing at selective heights above the bottom of the housing to space the extensible plunger relative to the strike plate on the door frame when the latch assembly is installed in the cargo door assembly. A lever arm operatively connected to the latch handle in the handle unit engages a rotating plunger gear mounted to the side of the carriage assembly to actuate the plunger between its latched and unlatched positions. The lever arm has an arcuate contact edge that engages the plunger gear to ensure that the action of the lever arm and plunger gear provides a sufficient and consistent travel of the extensible plunger between its latched and unlatched position regardless of the spacing height of the plunger carriage within the plunger housing.

The above described features and advantages, as well as others, will become readily apparent to those of ordinary skill in the art by reference to the following detailed description and accompanying drawings.

### BRIEF DESCRIPTION OF THE DRAWINGS

The present invention may take form in various system and method components and arrangements of system and method components. The drawings are only for purposes of illustrating exemplary embodiments and are not to be construed as limiting the invention. The drawings illustrate the present invention, in which:

FIG. 1 is a partial perspective view of a cargo door assembly using an embodiment of the latch assembly of this invention;

FIG. 2 is partial exploded view of an embodiment of the latch assembly of this invention, showing the handle unit and the plunger unit;

FIG. 3 is another exploded view of the latch assembly of FIG. 2;

FIG. 4 is a sectional view of the latch assembly of FIG. 2;

FIG. 5 is another partial exploded view of the latch assembly of FIG. 2 showing the plunger unit without a carriage spacer;

FIG. 6 is a sectional view of a typical cargo door assembly showing the latch assembly in its latched position;

FIG. 7 is a sectional view of the typical cargo door assembly of FIG. 6 showing the latch assembly in its unlatched position;

FIG. 8 is a bottom view of the typical cargo door assembly of FIG. 6 showing the latch assembly in its latched position;

FIG. 9 is a bottom view of the typical cargo door assembly of FIG. 6 showing the latch assembly in its unlatched position;

FIG. 10 is another partial exploded view of the latch assembly of FIG. 2 showing the plunger unit with a carriage spacer;

FIG. 11 is a sectional view of another typical cargo door assembly having a thinner gasket showing the latch assembly in its latched position; and

FIG. 12 is a sectional view of the typical cargo door assembly of FIG. 11 showing the latch assembly in its unlatched position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

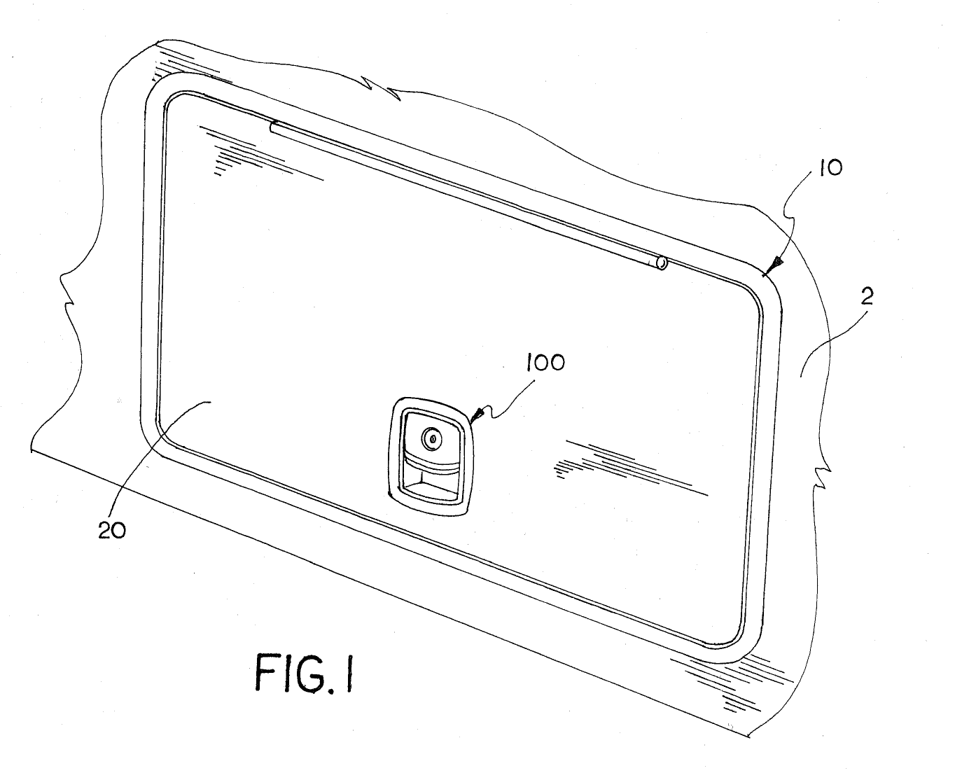

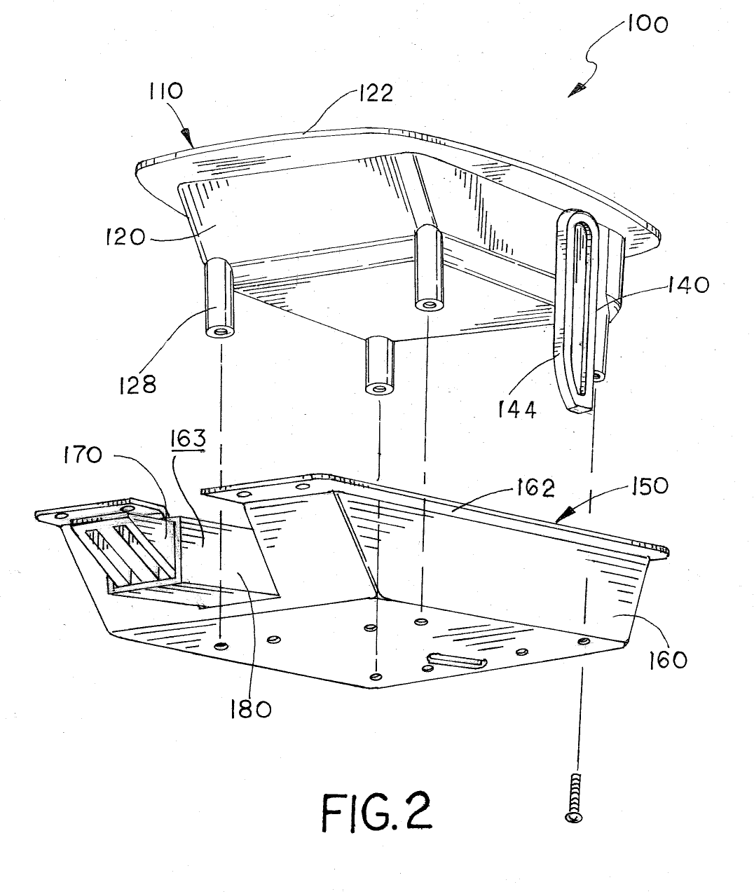

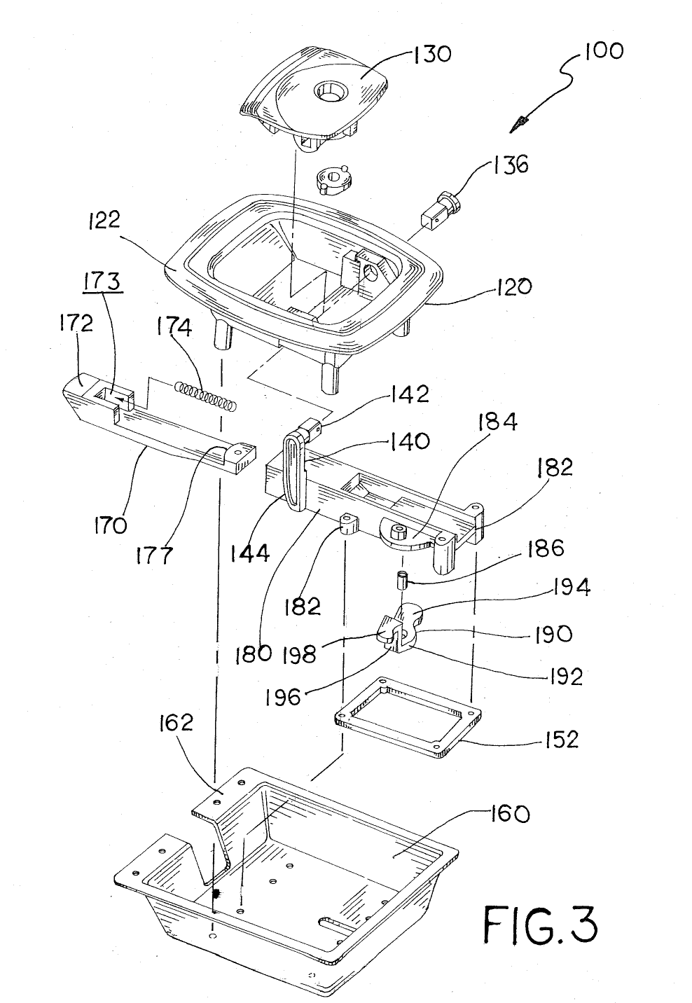

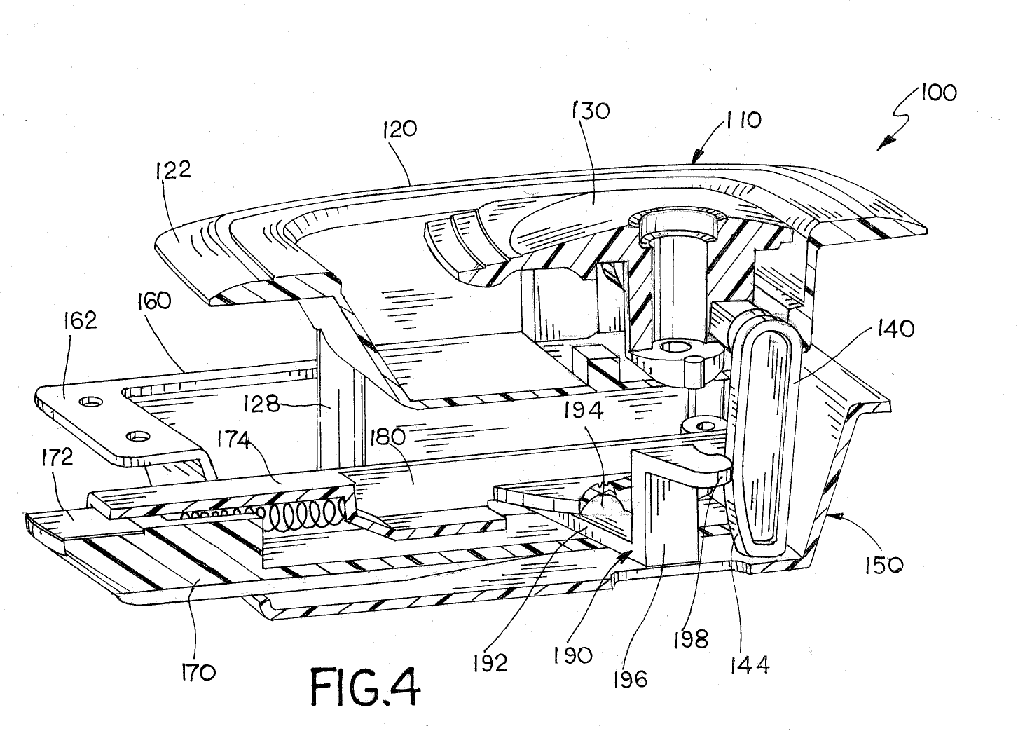

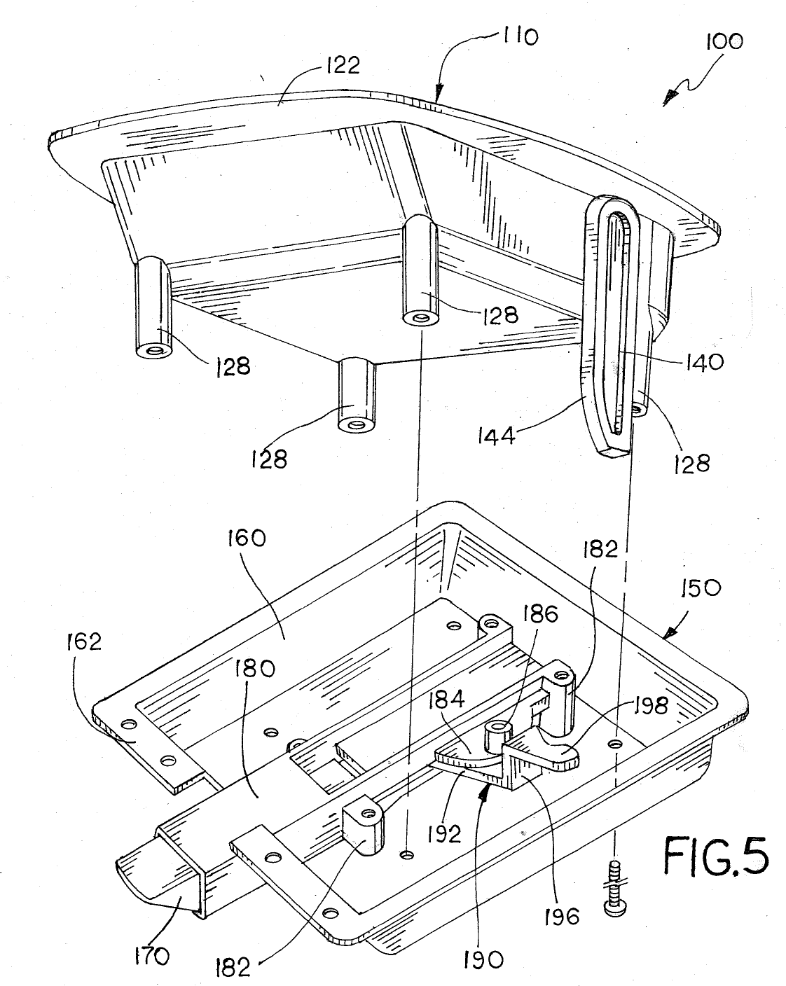

Referring now to the drawings, FIGS. 1-12 illustrate an exemplary embodiment of the door latch assembly of this invention, which is designated generally as reference numeral 100. Latch assembly 100 is designed for use with conventional cargo door assemblies 10 found on recreational vehicles, buses, trailers or the like; however, the latch assembly may be adapted for use in other applications as desired. As shown, cargo door assembles 10 include a door frame 12 set within an opening in the vehicle sidewall 2 and a cargo door 20 hinged to one side of the door frame. Cargo door 20 is of conventional design and construction having inner and outer skins 22 and 24 covering a flat inner core 26. Door frame 12 is constructed generally of an extruded metal, such as aluminum or steel and is affixed to sidewall 2 around the sidewall opening. Door frame 12 includes a side flange 14, which cargo door 20 abuts against when the door is closed. Door frame 12 also includes strike plate 18, which is engaged by the latch assembly 100 to hold the door closed and a gasket 16 bonded to the flange 14 which provides a contact seal for the cargo door assembly.

Latch assembly 100 is mounted to cargo door 20 and holds the swinging cargo door in its closed position. Latch assembly 100 uses a two piece design that includes a handle unit 110 and a plunger unit 150. Handle unit 100 is seated within a cut-out 21 formed within cargo door 20. Plunger unit 150 is mounted to the outside of the inner door skin 14 over cut-out 11. Handle unit 110 and plunger unit 150 are held together sandwiching cargo door 20 therebetween by screws 129. Handle unit 110 and plunger unit 150 each have a housing 120 and 160, respectively. Housing 120 is disposed within cut-out 21 and has a peripheral flange that overlies the outer skin 12 of cargo door 10 around cut-out 11. Plunger housing 160 extends from the inside of cargo door 20 and has peripheral flange 162 that abuts against inner skin 14 around cut-out 21. Four mounting posts 128 extend from the bottom of handle housing 120. Screws 129 extend through bores in the bottom of plunger housing 160 and turn into threaded bores in post 128 of the handle housing 120. One skilled in the art will note that latch assembly 100 may be readily modified to accommodate variations in the thickness of cargo door 20 by simply lengthening screws 129 that hold handle unit 110 and plunger unit 150 together.

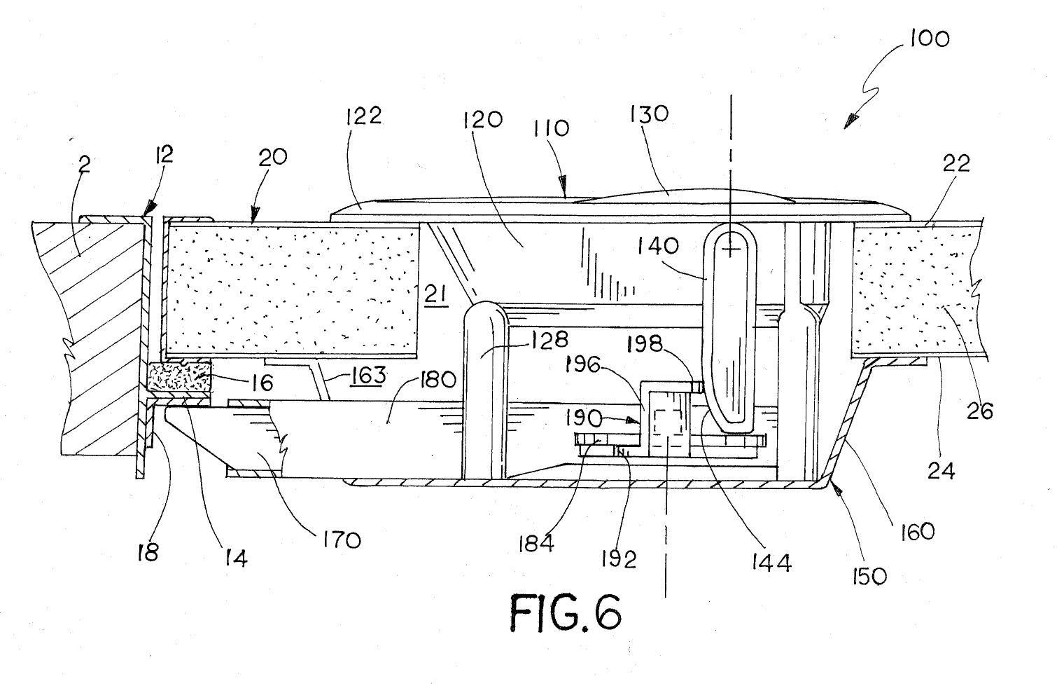

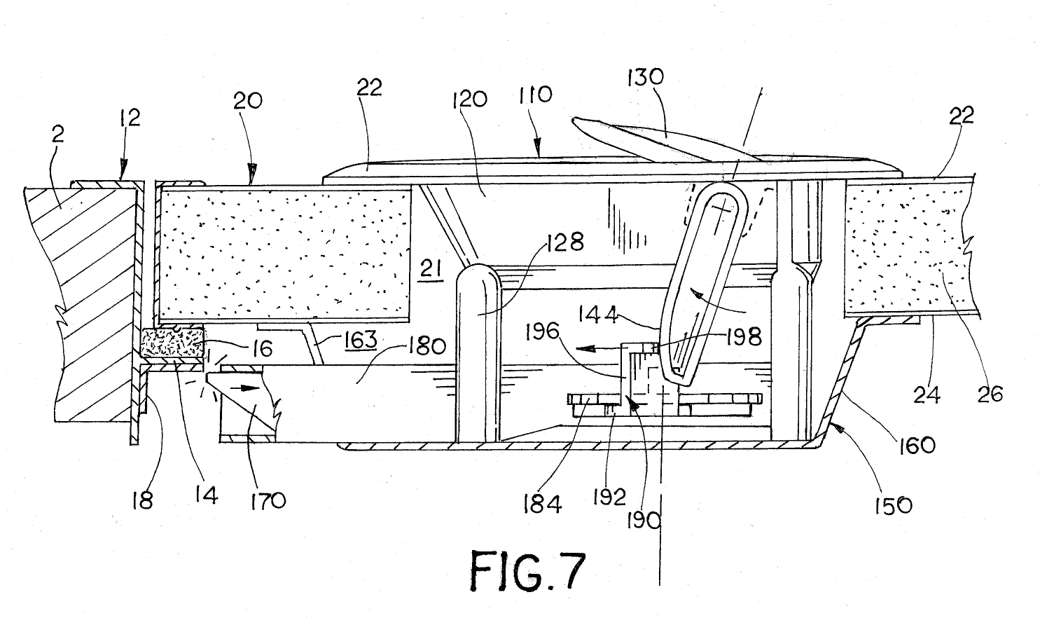

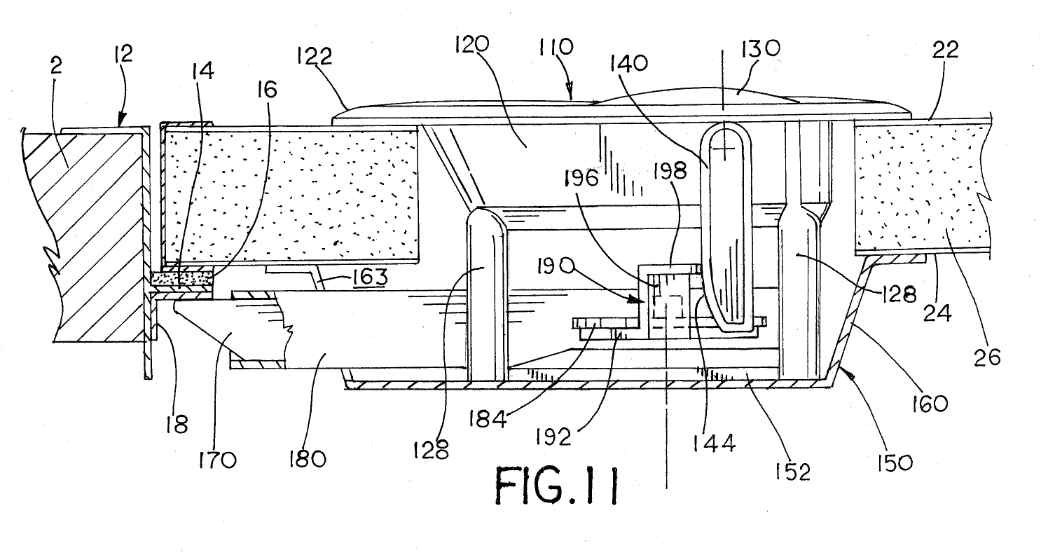

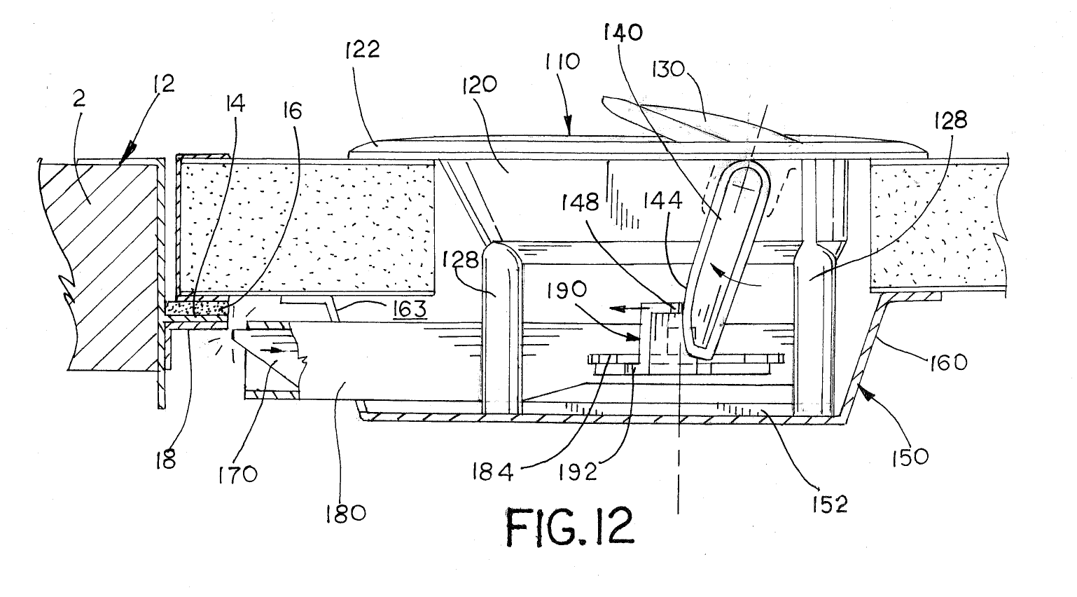

Handle unit 110 also includes a latch handle 130, which is pivotally seated within a recessed handle well 121 formed in handle housing 120. Handle 130 is generally flush with flange 122 when the handle is in its latched position (FIGS. 6 and 11) and pivoted outward from handle well 121 when in its unlatched position (FIGS. 7 and 12). Handle 130 pivots about two pivot pins 136 and 142 that extend through bores formed in handle housing 120. Each pivot pin 136 and 142 has a tenon end that seats within a mortise formed on opposite sides of handle 130, so that both pivot pins 136 and 142 rotate when latch handle 130 is manually rotated between its latched and unlatched positions. Pivot pin 142 also includes an integral lever arm 140, which also pivots with the manual movement of latch handle 130. Lever arm 140 has an arcuate contact edge 144 at its distal end. Handle unit 110 may also include a cylinder key lock mechanism (not shown) disposed within a bore formed in latch handle 130. The key lock mechanism allows the latch assembly to be securely locked to prevent unauthorized opening of the cargo door without a key (not shown). Such key lock mechanisms are well known in the art and are therefore not fully described herein.

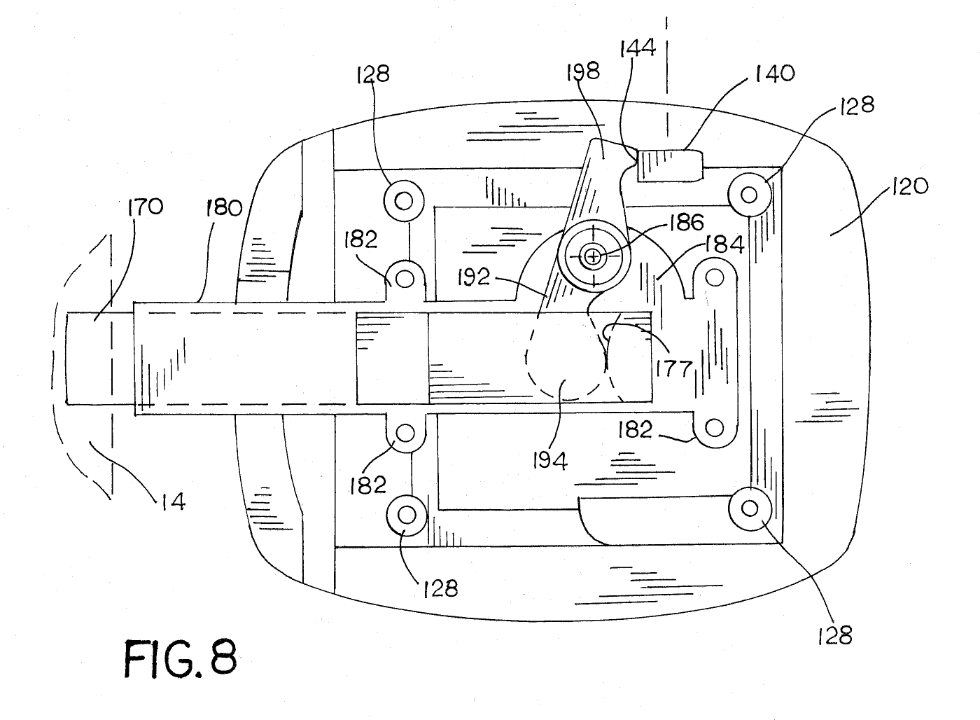

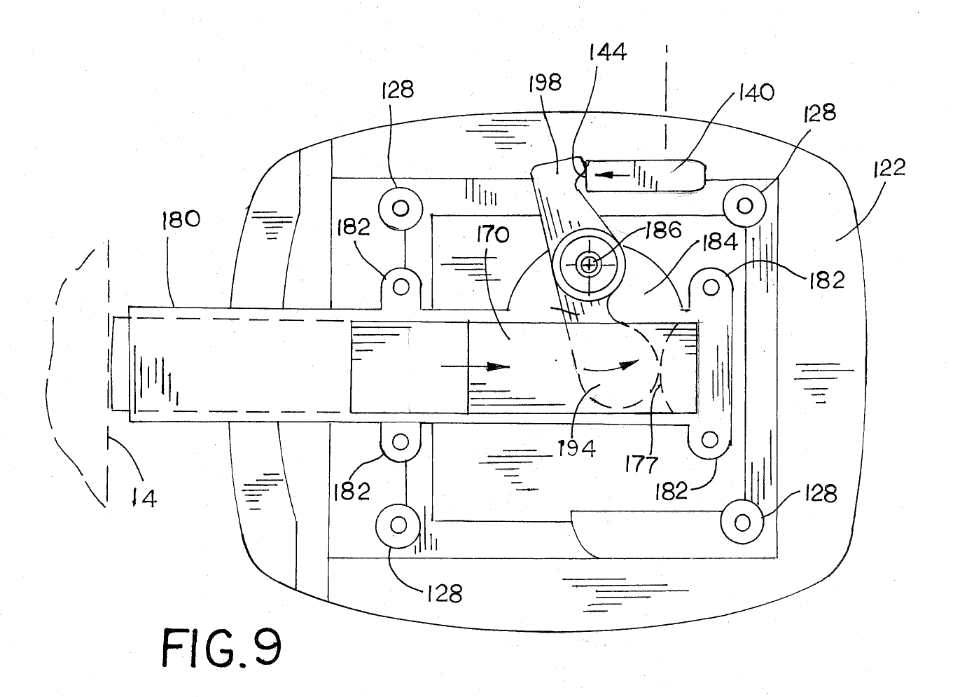

Plunger unit 150 also includes a plunger 170, a plunger carriage 180 and a plunger gear 190. Plunger 170 is extensibly disposed within a longitudinal channel 181 in carriage 180 between a retracted “unlatched” position where the distal end is retracted within carriage 180 and an extended “latched” position where the distal end of plunger 170 extends from carriage 180 through a slot opening 161 in plunger housing 160. Plunger 170 is biased outward toward its latched position by a plunger spring 174. One end of spring 174 is seated within a spring recess 173 formed in the distal end of plunger 170 and the other end abuts against an internal shoulder (not shown) formed in carriage 180. The proximal end of plunger 170, which is disposed within channel 181 has a forward facing arcuate contact surface 177. Carriage 180 has an integral side flange or ear 184, which supports a rotatable plunger gear 190. Plunger gear 190 has a flat base 192, an integral upright 196 extending perpendicularly from base 192 and a contact head 198 integrally extending from upright 196. Plunger gear 190 rotates about a pin 191 that extends through aligned bores in plunger gear base 192 and carriage side flange 184. As best shown in FIGS. 8 and 9, plunger gear base 192 has a lob 194 that extends into carriage channel 181 and sits over plunger 170 to engage contact surface 177 of plunger 170. Lever arm 140 abuts contact head 198 along its contact edge 144 so that rotation of lever arm 140 causes plunger gear 190 to rotate pulling plunger 170 from its latched position to its unlatched position.

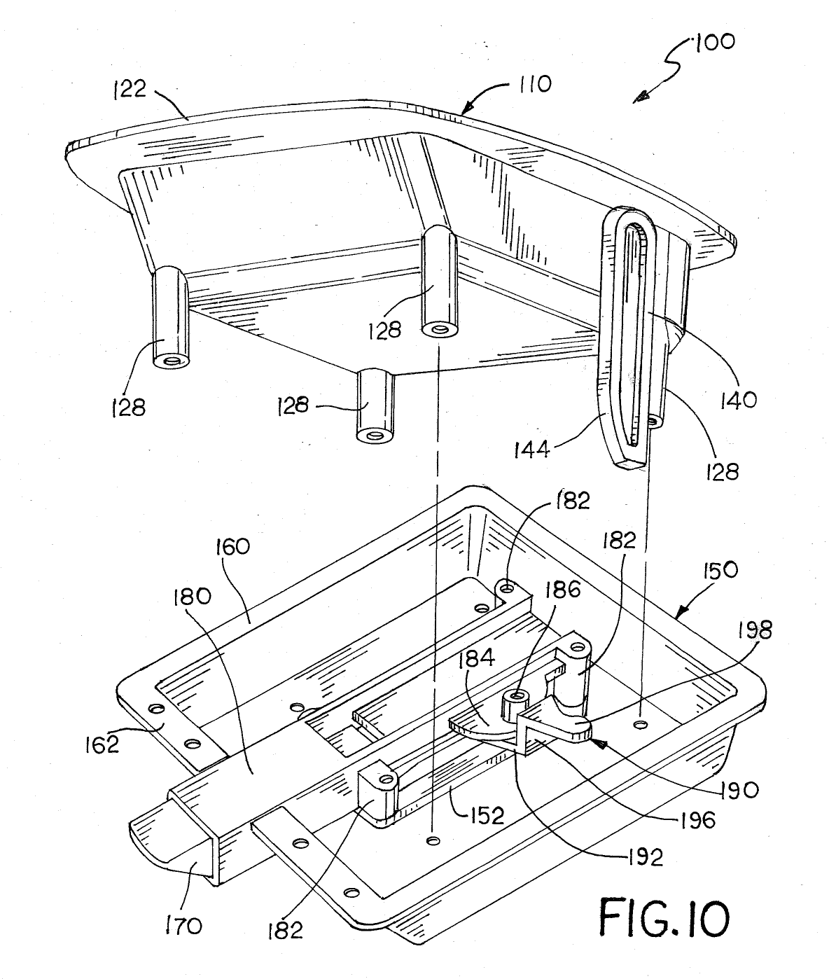

Carriage 180 is mounted to the bottom of plunger housing 160 by screws (not shown). Carriage 180 can be mounted directly to the bottom of plunger housing 160 (FIGS. 6-9) or elevated above the bottom of the housing using one or more spacers 152 (FIG. 10-12). Spacers 152 are inserted and/or stacked between plunger carriage 180 and the bottom of plunger housing 160 to elevated the carriage within the housing and selectively adjust the position of plunger 170 relative to the strike plate of outer door frame 12. It should be noted that the use of spacers 152 not only elevates plunger carriage 180 within plunger housing 150, but also changes the contact point where plunger gear 190 engages lever arm 140 along contact edge 144. The curvature of contact edge 144 of lever arm 140 ensures that the rotation of plunger gear 190 caused by manually pivoting handle 130 outward provides enough travel to actuate plunger 170 between its latched and unlatched position.

One skilled in the art will note that the latch assembly of this invention accommodates for dimensional and structure variations is cargo door assemblies to ensure a secure latching mechanism. The two piece design with separate handle and plunger units that sandwich the cargo door allows the latch assembly to be used with cargo doors of differing thickness by simply using longer connecting screws and selectively replacing the lever arm with one of a suitable length for the given thickness of the cargo door. Any suitable lever arm will have a similar arcuate contact face to ensure proper plunger travel.

The latch assembly allows for selective adjustment of the position of the plunger relative within the assembly itself to ensure that the plunger properly engages the door frame to securely hold the cargo door closed. The use of spacers to elevate the plunger carriage within the plunger housing allows the selective positioning of the extensible plunger relative to the strike plate or door frame, which compensates for dimensional or structural variations in door frames, strike plates, gaskets and the cargo doors. The spacers can be readily inserted and stacked under the plunger carriage to provide the proper height alignment for the extensible plunger relative to the door frame to securely hold the cargo door closed with the proper seal.

It should be apparent from the foregoing that an invention having significant advantages has been provided. Moreover, the embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. A latch assembly for a door assembly including a door frame and a door pivotally connected to the door frame for movement between an open position and a closed position, the latch assembly comprises:
a first (plunger) unit adapted to be mounted to on one side of the door, the first (plunger) unit includes a first housing, a carriage disposed within the first housing, an elongate plunger reciprocally supporting the carriage, and a gear pivotally mounted to the carriage for reciprocating the plunger between a latched position where the plunger engages the door frame to hold the door closed against the door frame and an unlatched position where the plunger is spaced from the door frame to allow the door to swing open from the door frame, the carriage adapted to be mounted within the first housing to selectively position the plunger within the plunger housing relative to the door frame when the latch assembly is mounted the door; and
a second (handle) unit adapted to be mounted to the other side of the door and operatively connected to the handle unit, the second unit includes a second housing, a handle part pivotally connected to the second housing for movement between a first position and second position, a lever arm connected to the handle part and operatively engaging the gear to actuate the plunger between the latched position when the handle part is in the first position and the unlatched position when the handle part is in the second position.

2. The latch assembly of claim 1 wherein the first unit part also includes a flat spacer mounted between the carriage and first housing, the spacer having a set thickness to selectively position the plunger within the first housing.

3. The latch assembly of claim 1 wherein the plunger includes a distal end that extends from the carriage to engage the door frame when the plunger is in the latched position.

4. The latch assembly of claim 1 wherein the lever arm has an arcuate contact edge that abuts the gear along the length of the contact edge thereof when the handle part is manually moved between the first position and the second position.

5. The latch assembly of claim 1 wherein the plunger has a contact part, the gear has a first contact part engaging the plunger and a second contact part engaging the lever arm.
